(19) United States
(12) Patent Application Publication
(10) Pub. No.: US 2025/0282123 A1
(43) Pub. Date: Sep. 11, 2025

(54) PANEL AND ADHESIVE SYSTEM FOR PANELS

(71) Applicant: UNILIN, BV, Wielsbeke (BE)

(72) Inventor: Benjamin CLEMENT, Wielsbeke (BE)

(21) Appl. No.: 18/862,646

(22) PCT Filed: May 2, 2023
(86) PCT No.: PCT/IB2023/054561

§ 371 Date: Nov. 4, 2024

Related U.S. Application Data
(60) Provisional application No. 63/339,120, filed on May 6, 2022.

(51) Int. Cl. B32B 21/14; B32B 7/12; B32B 13/10; B32B 19/00; B32B 21/04; B32B 21/06; B32B 21/08; B32B 29/06

(52) U.S. Cl. CPC B32B 21/14; B32B 7/12; B32B 13/10; B32B 19/00; B32B 21/042; B32B 21/06; B32B 21/08; B32B 29/06; B32B 2250/02; B32B 2451/00

(57) ABSTRACT

A panel includes two or more units connected to each other. At least one of the units is a bonding unit that provides adhesion between itself and at least one other of the units. The adhesion is decreasable by a debonding activator. An adhesive system for panels is provided along with use of the adhesive system and a method for disassembling a panel.

The present invention pertains to the technical field of panels, more particularly panels with two or more units connected to each other, wherein at least one of said units is a bonding unit that provides adhesion between itself and at least one other said unit. Further, the invention relates to an adhesive system for panels. In a further aspect, the invention relates to a method for disassembling a panel. In another aspect, the invention relates to use of the adhesive system.

A panel, such as a floor, wall or furniture panel, usually features one or more units, such as layers, for example a substrate or a core layer and a top layer, which layers may further comprise multiple sublayers. Said units within the panel usually have different functionalities and therefore materials from which these units are made are often different with respect to each other, making such panel multimaterial. The high cost of the materials as well as the environmental issues are increasing the demand for recycling and reusing the panels. When such panels after their use are to be recycled in order to retrieve the materials from which they are made, it is thus beneficial that the different materials originating from the different units can be recycled via separated streams. It may be the most desired and the most expedient way to that aim, to firstly physically separate the units of the panel from each other, and subsequently recycle the separated units in separated batches or streams.

However, an end-of-life disassembly is labor intensive and costly. In most cases, it is not even possible to separate the different units from each other. The adhesives that are commonly used in the field, are permanent adhesives such as thermoset adhesives, for example thermoset polyurethane adhesives, which have a high adhesive bond strength, and which achieve a durable bonding of the units which is cumbersome to break. Even when such bonding is broken under the application of high forces, it is in most cases impossible to achieve a clean separation of the different units, for example, in the case of different layers connected to each other, it is not possible to achieve a clean delamination, i.e. a delamination which separates the different layers from each other. The delamination known in the prior art typically leads to presence of contaminants, such as glue and/or various residues, which contaminants stay on in the units making it difficult to recycle and/or re-use such units. Consequently, the recycling of the multimaterial panels will result in a contaminated stream of recycled material because of the intrinsic imperfect delamination.

Some of the prior art documents recognize the need for easier delamination at the end of life of a panel. For example, WO2022/069629 discloses a decorative panel comprising a top layer and a core layer which are directly or indirectly adhered to each other by a switchable adhesive having an adjustable adhesive strength, wherein the switchable adhesive is free of starch and preferably comprises polyurethane. In this decorative panel, the adhesive strength of the switchable adhesive is adjustable from an operational value suitable for the panel during its use, to a reduced value suitable for the panel to be recycled, by exposing the switchable adhesive to irradiation. For this the top layer is at least partially permeable for irradiation.

The prior art seems to be lacking a panel which would allow that units could be more easily separated and recycled upon the end of its usage, also known as the end of the life of said panel.

The present invention, in the first place, aims to provide a panel which could be easier re-used and/or recycled at end-of-life of said panel.

With this aim, the present invention in accordance with a first independent aspect, is a panel comprising two or more units connected to each other, wherein at least one of said units is a bonding unit that provides adhesion between itself and at least one other said unit, wherein said adhesion is decreasable by a debonding activator.

It should be understood by a skilled person that the units of the panels may be layers and/or different subparts without departing from the scope of the invention. Said units may be of substantially the same or different material. Preferably, at least two of said units are composed of substantially different materials, making the panel a multimaterial panel.

Preferably, said at least one bonding unit and said at least one other unit are separated upon the activity of the debonding activator. Preferably, said at least one other unit is separated in a manner that said at least one other unit is substantially free of the at least one bonding unit. With “substantially free” is indicated that possible residues of said bonding unit are present in an amount less than 5 weight percentage, preferably less than 3 weight percentage, more preferably less than 1 weight percentage and most preferably less than 0.1 weight percentage. Alternatively, the residues of the at least one bonding unit may remain present on said at least one other unit of the panel, and this for example in an amount of more than 5 weight percentage.

The bonding unit provides adhesion between itself and at least one other said unit. Preferably the bonding unit provides adhesion between at least two units and thus connects at least two units to each other. Said adhesion is decreasable by a debonding activator. Said adhesion preferably provides connections between itself and at least one other said unit, wherein the number of said connections are reduced by said debonding activator. For example, the number of connections is reduced by at least 20%, preferably at least 30%, more preferably at least 40%, and most preferably at least 50% in the presence said debonding activator. For example, if the bonding unit provides adhesion between two units, said units can be separated from each other when the panel gets exposed to said debonding activator.

Preferably, said bonding unit has a certain adhesive bond strength in use, and when said bonding unit is exposed to said debonding activator, for example to recycle said panel at end-of-life, the adhesive bond strength decreases. The adhesive bond strength can be defined as the force necessary to pull the adhesive bond apart. In case of the panels comprising for example multiple layers, the adhesive bond strength may be defined as a peel resistance, as defined in European Standard EN 431:1994, issued by the European Committee for Standardization. In said standard, the peel resistance is defined as the force applied to the width of one layer of a panel, for example of a resilient floor covering panels, which separates it from another layer.

Preferably, by exposing a panel to the debonding activator, the said adhesive bond strength is reduced by at least 10%, preferably at least 20%, more preferably at least 30%, even more preferably at least 50%, and most preferably at least 70%. Such reduction of the adhesive bond strength allows for a better separation of the units of the panel and further separate recycling of said units in separate batches and/or streams.

Preferably, by exposing the panel to the debonding activator, a reduction of the peel resistance as measured according to EN 431/1994, to below 100 N/50 mm, preferably below 75 N/50 mm, more preferably 50N/50 mm, most preferably below 25 N/50 mm occurs.

Preferably, said debonding activator comprises heat and/or humidity and/or radiation and/or chemicals. It should be understood that the debonding activator is not limited to the above list. Preferably, the debonding activator comprises at least two different components, such as for example heat and humidity, or heat and radiation. As a result, it is not likely that the adhesion will decrease during normal use of the panel, for example, in case the panel is a floor panel, wall panel or furniture panel, during use of said panel in a floor, wall or furniture. Only at end-of-life it is desirable to reduce the adhesion of the bonding unit.

Heat as a debonding activator comprises subjecting the panel to an increased temperature, such as for example a temperature of about 60° C., 70° C., 80° C., 90° C., 100° C., 110° C., 120° C., 130° C. or 140° C.

Humidity, as a debonding activator means exposing the panel to an atmosphere having a water vapor content higher than the maximal air-humidity at a certain temperature, preferably higher than at least 10%, preferably at least 20%, more preferably at least 30%, most preferably at least 50%, than the maximum air humidity at a certain temperature.

The radiation preferably comprises at least a UV radiation, and/or an UV-VIS radiation and/or IR radiation and/or microwave radiation and/or electromagnetic radiation, exposure to the radio-frequency waves and the like.

Preferably the adhesion of the bonding unit will not decrease when the panel is exposed to sunlight and/or exposed to water when cleaning the panel during use of said panels.

In an embodiment, the debonding activator comprises chemicals such as pH regulators, for example acidifiers or alkaline compounds, solvents, in particular organic solvents or mixtures of water and polar or non-polar organic solvents, and the like. The choice of the chemical is triggered by the nature and the material of the units of the panel.

Preferably, the panel could comprise additives which can be triggered by said debonding activator, which additives may be for example particulate materials, such as microcapsules, nanocapsules, metal and non-metal particles, expandable particles, foaming agents, cellulose containing particles such as various cellulosic and lignocellulosic fibers. The above mentioned additives may be activated or “triggered” by said debonding activator and lead to debonding of the different units within the panel. By activating of said additives, the detachment of different units within the panel, for example the multimaterial panel, may be achieved. Alternatively, the additives may be substances capable of changing from crystalline to amorphous form and/or vice-versa, i.e. from amorphous to crystalline form, upon the exposure to the debonding activator.

In a preferred embodiment, said additives are at least present in a said bonding unit of the panel. Preferably, said additives are various particulate materials as for example as described above, such as metal and non-metal particles, expandable particles and the like. Particularly preferred particulate materials are for example ferromagnetic particles such as iron-oxide, carbon nanotubes, expandable particles such as glass sphere particles containing evaporable matter, expandable thermoplastic microspheres encapsulating a gas which can expand and break the microspheres when heat is applied (e.g. as commercialized under the Expancel brand), ‘expancell’ being a filler and blowing agent, and the like.

In a particularly preferred embodiment, the additives are present exclusively in the bonding unit of the panel. Such panel is particularly suitable to be recycled/reused at the end of life, as the presence of the triggerable additives allows for a more efficient and precise separation of the units of the panel.

The units of the panel can comprise one or more of the following characteristics of the non-exhaustive list below, as long as they do not contradict each other:
the units comprise layers;
at least one unit comprises a veneer layer, for example is a veneer layer;
at least one unit is a resin impregnated paper, wherein said resin preferably is a thermoset, such as an aminoplast polymer-urea formaldehyde (UF), melamine urea formaldehyde (MUF), melamine urea phenol formaldehyde (MUPF) and the like;
at least one unit is a wear layer, said wear layer preferably comprising mechanical particles, such as corundum and aluminum oxide;
at least one unit is a decorative layer, comprising for example a printed paper or a printed foil;
at least one unit is a thermoplastic material containing layer, such as SPC (Solid plastic composite), WPC, foamed or non-foamed polyvinylchloride (PVC) and/or polyolefin and/or polyester based layers;
at least one unit is a dimensionally stable polymer core layer, for example a sheet molding compound (SMC), a bulk molding compound (BMC) or an acrylic based layer;
at least one unit is a high pressure laminate (HPL) or continuously pressure laminate (CPL);
at least one unit comprises mineral fillers, and is for example a cement based layer, a MgO based layer, a gypsum based layers, and the like;
at least one unit comprises a geopolymer based layer;
at least one unit is a chipboard, particle board, oriented strand board, a timber layer, and the like;
at least one unit comprise (ligno) cellulosic particles, such as wood chips, wood shavings, plant fibers-for example wood fibers, flax fibers, hemp fibers, etc.
at least one unit comprises a glue, preferably a bio-based glue, such as a glue based upon lignin and/or starch and/or sugar;
at least one bonding unit comprises additives, wherein said additives are preferably chosen from the following list: thermally expanding particles (e.g. expandable thermoplastic microspheres encapsulating a gas which can expand and break the microspheres when heat is applied), metallic particles, preferably ferromagnetic particles, non-metallic particles, blowing agents, additives capable of changing from crystalline to amorphous form and/or from amorphous to crystalline form;
at least one unit comprises a hydrolysable glue.

The panels can be floor panels, wall panels or furniture panels. Said panels can comprise coupling elements which have been milled in the panel. Of course, the adhesion of the bonding unit preferably does not decrease during said milling of coupling elements.

Preferably, said debonding activator comprises at least heat of at least 70° C., preferably at least 80° C. The panels may reach the temperature of 50-65° C. during transport. Also, in use, when being for example installed in area exposed to sunlight, temperatures can reach up to 65° C. Heat of at least 70° C. is particularly preferred, since lower temperatures can be present during normal use of said panel. If heat is used for manufacturing the panels, for example during a lamination step if said units are different layers, one can make sure that the temperature is below the abovementioned temperatures of the debonding activator, after the delamination step. For example if said panel is pressed during the lamination step with a discontinue press, one could cool said press before opening the press to release said laminated panel. This to reduce the risk of unwanted delamination.

Preferably, said debonding activator comprises at least heat of at most 140° C., preferably at most 100° C., more preferably at most 90° C. With this feature is indicated that, when the debonding activator comprises heat, the adhesion of the bonding unit will start to decrease at temperatures lower than 140° C., preferably lower than 100° C., more preferably lower than 90° C. If temperatures higher than 140° C. can be avoided, this is energy and cost efficient. At the same time, this ensures that the materials of the units will not degrade and can be re-used. When the bonding unit has the abovementioned adhesive bond strength, preferably, by subjecting the panel to the debonding activator which comprises heat, preferably heat of at least 70° C. and at most 140° C., the adhesive bond strength-measured according to European Standard EN 431/1994-is reduced by at least 10%, preferably at least 20%, more preferably at least 30%, even more preferably at least 50%, and most preferably at least 70%. The adhesive bond strength of the bonding unit of the panel is reduced as the temperature is increased. The provision of heat in the preferred temperature range of at least 70° C. and at most 140° C., allows for a good reduction of the bonding strength, without the need for excessive energy consumption and/or destruction of one or more of said units, such that separated units are suitable for re-use and recycling.

Preferably, the debonding activator comprises heat and at least one additional component, such as humidity and/or radiation.

In a preferred embodiment, said units comprise at least two base units, wherein said bonding unit preferably comprises a glue which connects said at least two base units to each other.

Further preferably, said glue is chosen based on the material characteristics of the bonding unit and/or at least two base units, and preferably, said glue comprises further additives which contribute to the decrease of said adhesion when the panel is exposed to the debonding activator.

Also further preferably, said at least two base units can be layers connected one above the other, and said bonding unit is then a glue layer comprising said glue, with said glue layer connecting said at least two base units.

The units of a preferred panel comprise at least two base units, wherein the at least two base units comprise a first base unit and a second base unit. The bonding unit provides an adhesive bonding between the first base unit and the second base unit.

It is a benefit of such embodiments that the first base unit can be separated from the second base unity, allowing reuse of the first base unit, or of the second base unit or of both the first base unit and the second base unit.

Preferably, the first base unit provides a top layer to the panel and the second base unit provides a substrate to the panel. Such embodiments have the benefit that the top layer can be separated from the substrate of the panel. Consequently, the substrate of the panel can be used to make a new decorative panel by applying a new decorative top layer onto the substrate.

The top layer preferably comprises a décor layer comprising a printed décor; more preferably a digitally printed decor. Such embodiments allow to replace the top layer and applying a new decorative top layer, e.g. comprising a different printed décor.

The top layer can comprise a veneer.

The first base unit preferably comprises a resin impregnated printed paper sheet, a printed polymer film, or a high pressure laminate (HPL).

The top layer preferably comprises printed décor and a surface texture, preferably wherein the surface texture is provided in register with the printed décor.

A surface texture can be provided via digital texturing.

The second base unit can be selected from a wood based board (e.g. a wood panel, a particle board, a wood fiber board); a synthetic based board (e.g. a polyvinyl chloride based board or an cross linked polyester board or a polypropylene board), or a mineral board (e.g. a magnesium oxide based board, a gypsum board or a cement based board).

These examples of second base units are durable and can—after removal of the first base unit—be re-used by applying a new second base unit; preferably comprising a decorative top layer.

The bonding unit providing the adhesive bonding between the first base unit and the second base unit preferably comprises additives providing that said adhesive bonding is decreasable by a debonding activator. Preferably wherein said additives are selected from one or a combination of more than one of the list consisting of
metallic particles;
non-metallic particles;
thermally expanding particles, e.g. expandable thermoplastic microspheres encapsulating a gas which can expand and break the microspheres when heat is applied;
blowing agents;
hydrolysable agent;
azodicarbanamide;
expandable graphite;
polycarboxylic acids;
sulphonylhydrazides;
additives capable of changing from crystalline to amorphous form and/or from amorphous to crystalline form.

Also further preferably said bonding unit, which can be a glue layer comprising said glue, connects at least said two base units, each base unit being chosen from the list: HDF (high density fiberboard), MDF (medium density fiberboard), laminate—for example a laminate comprising at least two resin impregnated papers such as a HPL or CPL, or a laminate comprising two thermoplastic based layers, plywood, veneer, parquet, SPC, thermoplastic layer, foamed thermoplastic layer, oriented strand board (OSB), rubber layer, carpet layer, linoleum layer, textile layer, non-woven fabric and/or glass fiber scrim layers, a resin impregnated paper, mineral board based layer such as a magnesium oxide based layer, cement based layer, gypsum based layer, particle board, geopolymer based layer.

It is possible that said at least two base units are the same units or said at least two base units can be different units. For example one said base unit can be a HDF, a MDF or a particle board, while the other said unit is for example a laminate or one resin impregnated paper.

Said bonding unit can be a glue layer comprises a glue. Further said glue layer can comprise one or more of the following components, as long as not contradictive:
additives which contribute to the decrease of said adhesion when the panel is exposed to the debonding activator;
a carrier, such as a paper sheet, a thermoplastic film/sheet, a reinforcement element, such as a glass fiber layer. For example the glue layer can be a resin impregnated paper, with said resin being for example a melamine formaldehyde resin.

In a preferred embodiment, wherein the panel comprises at least said two base units, the panel comprises at least a first said base unit comprising a HPL or a CPL or one or more veneers, a second said base said unit comprising a thermoplastic based layer and a said bonding unit preferably comprising additives, said additives preferably being one or more of:
metallic particles;
non-metallic particles;
thermally expanding particles (e.g. expandable thermoplastic microspheres encapsulating a gas which can expand and break the microspheres when heat is applied);
blowing agents;
hydrolysable agents;
azodicarbanamide;
expandable graphite;
polycarboxylic acids;
sulphonylhydrazides;
additives capable of changing from crystalline to amorphous form and/or from amorphous to crystalline form.

In said preferred embodiment, the thermoplastic based layer is adhered to for example a HPL by said bonding unit. Said thermoplastic based layer may or may not comprise several sublayers, typically comprises filled or non-filled, foamed or non-foamed thermoplastic material, such as a PVC, polyolefin and/or polyester thermoplastic material. The HPL provides rigidity, and robustness as well as a good scratch resistance and prolongs the duration and the life of such panel, in comparison with a similar panel only comprising thermoplastic based layers. The bonding unit preferably comprises additives, and preferably a glue, which additives are for example metallic particles, such as iron oxides and/or thermally expanding particles, such as glass spheres containing evaporable matter or e.g. expandable thermoplastic microspheres encapsulating a gas which can expand and break the microspheres when heat is applied. Upon activation with the debonding activator, wherein the debonding activator preferably comprises heat, the adhesive bond strength of the bonding unit is decreased and the HPL and the thermoplastic based layer could be easily separated and eventually reused or recycled.

In another preferred embodiment, wherein the panel comprises at least said two base units, said panel comprises at least a first said base unit comprising a HPL or a CPL or one or more veneers or a thermoplastic material and a second said base unit comprising a mineral based layer, said second base unit being preferably a magnesium oxide board, a cement board or a geopolymer board and a said bonding unit preferably comprising additives, said additives preferably being one or more of:
metallic particles;
non-metallic particles;
thermally expanding particles (e.g. expandable thermoplastic microspheres encapsulating a gas which can expand and break the microspheres when heat is applied);
blowing agents;
hydrolysable agents;
azodicarbanamide;
expandable graphite;
polycarboxylic acids;
sulphonylhydrazides;
additives capable of changing from crystalline to amorphous form and/or from amorphous to crystalline form.

In said another preferred embodiment, for example, a magnesium oxide board, a cement board or a geopolymer board mineral board, is adhered to an HPL by the bonding unit. The bonding unit can comprise additives, preferably metallic particles, such as iron oxides, and/or thermally expanding particles, such as glass spheres containing evaporable matter or e.g. expandable thermoplastic microspheres encapsulating a gas which can expand and break the microspheres when heat is applied. The panel may be particularly suitable for uses when the second base unit is hard material that is difficult to emboss. By having said HPL, one could easily provide the desired embossing. The application of a bonding unit allows for easier application of a HPL onto a said board and easier removal of it at the end of life of the panel, and allows for easier recycling and/or reusing of said units upon the end of life of the panel.

For the abovementioned embodiments comprising the HPL, the HPL preferably comprises at least two resin impregnated papers, with said resin for example being a thermoset resin such as an UF resin, a MUF resin or a MUPF resin. The HPL then preferably comprises a least a décor layer, which is a resin impregnated printed paper. This printed paper can be analogously or digitally printed, with the décor being for example a wood print or a stone print. Preferably the top layer of the HPL is a wear layer, being a resin impregnated paper comprising wear resistant particles such as corundum or aluminum oxide. The HPL preferably has one or more backing layers situated below the décor layer, which are resin impregnated kraft papers.

Preferably, at least one of said two base units is a multilayered base unit. The layers of a multilayered base unit can be composed of different material. The multilayered base unit can be a laminate comprising one or more of the following layers, as long as not contradictory:
a thermoplastic wear layer, preferably a rigid thermoplastic wear layer;
a decorative layer, such as a decorative printed paper and/or a decorative printed film;
a resin impregnated paper, preferably several resin impregnated paper;
a non-impregnated paper layer;
a hydrolysable glue layer;
a cellulosic material based layer
a thermoplastic layer;
a mineral based layer.

In a particularly preferred embodiment, at least one base unit is a HPL, comprising at least a wear layer, a décor layer, preferably being a printed paper décor layer and at least one bottom layer, preferably a resin impregnated paper. Preferably, said wear layer comprises wear resistant particles, such as corundum or aluminum oxide.

Said bonding unit, if it is a said glue layer, may comprise one or at least two layers. Preferably, each said layer or said at least two layers is one of the following as long as they do not contradict each other:
a thermoplastic layer comprising additives such as metallic particles and/or thermally expanding particles (e.g. expandable thermoplastic microspheres encapsulating a gas which can expand and break the microspheres when heat is applied);
a layer comprising additives capable of changing from crystalline to amorphous form and/or from amorphous to crystalline form;
a biobased glue layer;
a hydrolysable glue layer.

In a preferred embodiment, said at least one base unit comprises one or more of the following characteristics:
thermal resistance of at most 0.07 m2 K/W;
coefficient of thermal conductivity of at least 0.1 W/mK;
conductive additives, such as metallic (nano) particles and/or carbon based (nano) particles and/or nonmetallic (nano) particles, preferably Al₂O₃, CuO, Cu, SiO₂, TiO₂, CaCO₃);
a thickness of at most 5 mm;
is substantially free from voids, such as air pockets;
thermally expandable particles and/or blowing agents;
swellable material;
supramolecular polymers; and
ferromagnetic particles.

The thermal resistance and coefficient of thermal conductivity are measured by European Standard EN12664/2001.

In the above-mentioned preferred embodiment, at least one of the base units can be a layer, preferably a thin layer with a thickness of less than 5 mm, preferably less than 2 mm, more preferably less than 1 mm.

In the abovementioned preferred embodiment, at least one of the base units can be a layer substantially free of air pockets. Preferably, said base unit does not have any air-comprising irregularities in its structure which would disrupt the heat transfer between the units of the panel. As such, the base unit conducts heat more efficiently to the bonding unit, allowing for more efficient separation of the units.

In the abovementioned preferred embodiment, at least one of the base units can be a layer comprising metallic and non-metallic particles such as fillers. Carbon based particles, such as carbon nanotubes, are particularly preferred as they conduct the heat more efficiently, allowing for a better activation of the possible additives in the bonding unit and/or easier heating of the bonding unit, and thus easier separation of the units of the panel.

In a particularly preferred embodiment, said at least one base unit is a top layer of a thickness of at most 5 mm, preferably at most 2 mm. The top layer of said thickness may be suited to allow better thermal conductivity and thus better and more efficient debonding activation.

In a particularly preferred embodiment, two or more of said base units are: layers with a thickness of less than 5 mm; substantially free of air pockets; comprise metallic and non-metallic particles. Preferably said two or more base units are connected by a bonding unit comprising additives such as metallic particles and/or thermally expanding particles (e.g. expandable thermoplastic microspheres encapsulating a gas which can expand and break the microspheres when heat is applied). This particular embodiment is suitable to be activated by heat as debonding activator.

According to an embodiment, at least one of said base units comprises cellulosic particles, and said bonding unit connects said cellulosic particles. The panel is then for example a particle board, a MDF, a HDF or the like.

Said cellulosic particles may comprise cellulose, hemicellulose, lignocellulose and/or lignin, and can for example be plant fibers, wood fibers, wood chips, wood shavings, flax fibers, hemp fibers, bamboo fibers, recycled wood material and the like. Said cellulosic particles and bonding unit, comprising preferably a glue, may be pressed into a sheet or a board.

According to an embodiment, wherein said units are layers and wherein said units comprise said bonding unit and at least two base units, the panel comprises a water-impermeable first base unit which is a top layer, and a bonding unit being an adhesive layer comprising at least a thermoset resin, and a second base layer being a HDF.

In another embodiment, at least the bonding unit comprises a thermoplastic adhesive, for example a polyethylene based non-crosslinked adhesive.

In a particular embodiment said two or more units are layers, with said layers connected one above the other. Said bonding unit is preferably a layer comprising a thermoplastic or thermoset material, wherein said thermoplastic or thermoset material provides at least partly said adhesion.

Further for this particular embodiment, specific examples are panels comprising two or more of the following layers:
a HPL;
a thermoplastic wear layer;
a décor layer, preferably said décor being a printed paper or a printed thermoplastic film;
a thermoplastic layer preferably comprising a foamed or non-foamed PVC, polyesters and/or polyolefin material;
a layer which comprises fillers, said fillers being activatable by the debonding activator. In one example, the filler may comprise for example spheres with expandable material therein, such as expandable thermoplastic microspheres encapsulating a gas which can expand and break the microspheres when heat is applied (e.g. as commercialized under the Expancel brand), and/or may comprise metal particles;
a layer coextruded with other units/layers of the panel;
a layer which comprises polyester material, for example BMC or SMC.
A layer comprising polyethylene terephthalate (PET), which may be a recycled PET;
a decorative paper with an acrylic coating, preferably with a thermoplastic unit as the outermost layer, for example as a wear layer. In this particular embodiment, it is preferable that said wear layer comprises at least polyvinyl chloride (PVC);
a mineral based layer, such as for example a MgO board;
a bonding unit layer comprising a non-crosslinked polyethylene;
a bonding unit layer comprising a thermoset resin;
at least one layer being a HPL comprising a thermoset resin, said thermoset resin comprising additives such as metallic and/or non-metallic particles and/or thermally expandable particles and/or foaming agents and the like. Here, the debonding activator can comprise at least heat and/or moisture.
a HPL which comprises at least a thermoset resin impregnated paper. In a further preferred embodiment, said thermoset resin is a melamine-formaldehyde resin. Here, the bonding unit of the panel may or may not comprise a thermoset resin impregnated paper.
a layer comprising solid plastic composite (SPC) material, while the bonding unit comprises polymer cement material.

Said units of the panel can comprise at least two bonding units. In such case the panel is of a multilayer structure. Further preferably said units are layers and said units then comprise at least three base units wherein each bonding unit connects two consecutive base units to each other.

Preferably, the bonding unit comprises a glue and additives, wherein said glue provides said adhesion, and wherein said additives are provided to decrease said adhesion when triggered by said debonding activator.

Alternatively or additionally, additives can be present in at least one of the base units, wherein said additives contribute to the decrease of adhesion when triggered by said debonding activator. If additives are present in the bonding unit and in at least one base unit, these additives can be the same additives or can be different additives.

Preferably, the additives are swellable additives and/or expandable additives and/or conductive additives and/or hydrolysable additives.

Swellable additives can be one or more of the following:
cellulosic particles;
polysaccharides;
wood and plant fibers;
bamboo, flax and/or hemp based fibers;
wood chips;
mucilaginous material and/or hydrogels;
acrylic acid and its derivatives;
starch;
glycols;
bio-based adhesive material;
natural and synthetic foams and/or sponges;
expandable particles;
hydrolysable bio-based material.

Swellable additives may be present in any of the units of the panel, but preferably they are at least present in the bonding unit. In contact with water, or in humid conditions, the swellable additives are capable of adsorbing water thereby increasing the volume compared to the state before the exposure to the water and/or moisture. As such, these additives may be “triggered”, i.e. activated by the debonding activators such as humidity, water and/or temperature, and upon said activation may lead to easier and more efficient debonding of the layers.

Expandable additives can be one or more of the following:
one or more of the above mentioned swellable additives;
spheric material, such as glass spheres filled with evaporable material, for example expancell;
expandable thermoplastic microspheres encapsulating a gas which can expand and break the microspheres when heat is applied (e.g. as commercialized under the Expancel brand)
thermally expanding particles;
foaming agents such as mechanical and/or a chemical foaming agents.

Expandable additives expand and increase their volume typically when exposed to heat and/or humidity and/or chemicals. Presence of expandable additives as such may lead to more efficient and easier separation of the units. Preferably, said expandable additives are present in the bonding unit.

Conductive additives can be one or more of the following:
metallic particles, such as for example ferromagnetic particles;
non-metallic particles, such as carbon nanotubes.

Some non-limiting examples for the conductive particles are metal particles, silver-enchanted particles, metal oxides, metal hydroxides, metal nitrides, carbon containing materials, conductive polymers, magnetically soft materials, magnetically hard materials and the like.

The conductive particles are suited to be activated by heat and/or irradiation, and would allow for easier separation of units upon their activation. As such, the conductive particles are preferably located in the units such as the bonding unit and/or a said base unit of the panel.

Hydrolysable additives can be one or more of the following:
esters;
amides;
Diels-alder reactants;
sugars;
tannins and/or polyphenols;
lipids.

Hydrolysable additives may have their structure and/or form and/or composition and/or physio-chemical properties altered when exposed to the hydrolyzing agents. As such, the hydrolysable additives are preferably comprised in the bonding unit.

Preferably, the debonding activator may comprise heat and temperature, and is for example steam. If swellable additives are present, said steam can trigger said additives, resulting in swelling of said additives. If one or more of said units are or comprise swellable additives, such as (ligno) cellulosic particles, said steam could result in swelling of said last-named particles as such contributing to the decrease of adhesion of said bonding unit. Some non-limiting examples of swellable additives which may swell when being exposed to steam are for example glycols, cellulose, acrylic acid and/or hydrogels.

In a preferred embodiment, the additives may comprise spheric particles made for example of glass, and comprising evaporative material. In another preferred embodiment, the additives can comprise expandable thermoplastic microspheres encapsulating a gas which can expand and break the microspheres when heat is applied (e.g. as commercialized under the Expancel brand). In another preferred embodiment, the additives may be metallic particles. Such additives may be activated by a debonding activator such as heat, and cause a localized expansion and/or heated spots. In a further preferred embodiment, at least one of the base units is heat-conductive. In particularly preferred embodiment, said heat conductive base unit is a layer, preferably a top layer unit.

In a further preferred embodiment, the debonding activator comprises at least moisture, preferably is steam with a temperature of at least 195° C. and/or a pressure of at least 13-14 bar, and wherein the additives are preferably chosen from the list:
cellulosic particles;
plant based fibers; and/or
thermally expanding particles (e.g. expandable thermoplastic microspheres encapsulating a gas which can expand and break the microspheres when heat is applied).

Preferably, the debonding activator comprises at least temperature, preferably a temperature of above 70° C., and more preferably of above 80° C., most preferably of above 100° C., and wherein the additives are preferably chosen from the list:
thermally expanding particles (e.g. expandable thermoplastic microspheres encapsulating a gas which can expand and break the microspheres when heat is applied);
metallic particles, such as ferromagnetic particles;
non-metallic particles, such as carbon nanotubes.

Preferably, in absence of the debonding activator, the bonding unit of the panel provides an adhesive bond strength between said bonding unit and said at least one other unit, and that in the presence of said debonding activator said adhesive bond strength is reduced by at least 10%, preferably at least 20%, more preferably at least 30%, even more preferably at least 50%, most preferably at least 75 wt %. The adhesive bond strength is measured according to European Standard EN 431/1994.

Preferably, in the absence of the debonding activator, the adhesive bond strength between the units of the panel is at least 100N/50 mm, preferably at least 120N/50 mm, as measured according to European Standard EN 431/1994. Upon the exposure of at least the bonding unit of the panel to the debonding activator, the adhesive bond strength decreases to below 75 N/50 mm, more preferably 50N/50 mm, most preferably to below 25 N/50 mm.

In the preferred embodiment, in absence of debonding activator, the bonding unit of the panel provides an adhesive bond strength between said bonding unit and said at least one other unit, of more than 50 N/50 mm and preferably more than 75 N/50 mm and that in the presence of said debonding activator the adhesive bond strength provided by said bonding unit is less than 50 N/50 mm, preferably less than 25 N/50 mm.

In a preferred panel according to the invention, the bonding unit comprises a first bonding unit layer and a second bonding unit layer. The first bonding unit layer comprises a polymer and additives providing that the adhesive bonding is decreasable by a debonding activator; and the second bonding unit layer comprises an adhesive. The additives are preferably selected from one or a combination of more than one of the list consisting of
metallic particles;
non-metallic particles;
thermally expanding particles, e.g. expandable thermoplastic microspheres encapsulating a gas which can expand and break the microspheres when heat is applied;
blowing agents;
hydrolysable agent;
azodicarbanamide;
expandable graphite;
polycarboxylic acids;
sulphonylhydrazides;
additives capable of changing from crystalline to amorphous form and/or from amorphous to crystalline form.

It is a benefit of such embodiments that the first bonding unit layer can be applied; and that a standard glue can be used for the second bonding unit layer. Upon applying the debonding activator the bonds in the first bonding unit layer are broken.

The bonding unit is preferably oriented such that the first bonding unit layer is directed to the first base unit and such that the second bonding unit layer is directed to the second based unit; or vice versa.

According to a second aspect according to the invention, the present invention concerns an adhesive system for panels comprising one or more units, wherein said adhesive system is suitable for providing adhesion between itself and at least one unit of a said panel, wherein said adhesion is decreasable by a debonding activator, such as temperature and/or humidity and/or radiation and/or chemicals. It should be clear to the skilled person, that the adhesive system of the second aspect could be part of the panel as such. Therefore the adhesive system is particularly suited to be used in the panels according to the first aspect of the invention, wherein the adhesive system then preferably forms the bonding unit or is a part of said bonding unit. Said adhesive system can thus, in an embodiment where the said units are layers, be a glue layer which forms a said bonding unit or can be part of a glue layer which forms a said bonding unit. Said glue layer for example comprises a thermoset or thermoplastic glue and above-mentioned additives. Said thermoset or thermoplastic glue and additives, can thus for example be an adhesive system according to the second aspect of the invention, such that all the advantages and embodiments of said glue and additives as described for the first aspect, also apply to this second aspect. Said adhesive system can also be, in an embodiment wherein the bonding unit comprises a glue and the base units are cellulosic particles connected by said glue, the said bonding unit. If the glue layer is for example a resin impregnated paper, said adhesive system is then for example the resin. This resin, and thus the adhesive system, can comprise additives as described in the first aspect of this invention.

The adhesive system according to the second aspect of the invention can also be used in a “glue down” installations to glue down for example panels. The adhesive system is then not part of the panel as such but it is applied during the installation of the panels. Said “glue down” application of the adhesive system according to the second aspect of the invention allows for an easier disassembly of the panels, while avoiding the damage to said panels and, for example a subfloor, while at the same time minimizing the contamination of the panels with the typical adhesive components such as glue, in particular polyurethane glue, cement, and the like. The adhesive system can be a thermoplastic or thermoset glue comprising additives as described in the first aspect of the invention.

The adhesive system according to the second aspect of the invention can on its own form a separate layer. For this the adhesive system can be applied as a separate layer, for example in a liquid form. Said adhesive system can also be part of a panel comprising at least two layers, with one of said layers substantially comprising said adhesive system. For this the adhesive system can be coextruded with another sublayer. Said adhesive system can also be part of a layer comprising a carrier sheet. For this the adhesive system is for example embedded in a carrier sheet. Said carrier sheet can be thermoplastic film or a paper.

According to a possibility, the adhesive system may comprise a thermo-reversible or sensitive glue, which de-bonds upon to exposure to heat as a debonding activator. Such exposure to heat results in decreasing of the adhesive bond strength and allows for delamination, i.e. separation of the units.

According to a second possibility, the adhesive system may be hydrolysis sensitive, i.e. the adhesive system loses the adhesive bond strength upon exposure to humidity. For example, a melamine-formaldehyde thermoset resin which may or may not be impregnated on a paper sheet or may be present in a HDF may be part of a hydrolysis sensitive adhesive system.

According to a third possibility, the adhesive system may comprise a polymer material, such as supramolecular polymers. Such system may lose its adhesive bond strength upon the exposure to a debonding activator, such heat and/or irradiation, for example UV light.

According to a fourth possibility, the adhesive system may comprise additives, said additives being for example a micro-and/or nano-particles, evaporative polymer capsules, metallic and non-metallic particles, ferromagnetic particles, which additives would upon the exposure to the debonding activator lead to a decrease of the adhesive bond strength between the adhesive system and the units said system is adhered to. Some non-limiting examples for microparticles are thermally expanding particles (e.g. expandable thermoplastic microspheres encapsulating a gas which can expand and break the microspheres when heat is applied) or blowing agents.

Preferably, the adhesive system comprises a glue and additives, wherein said additives are triggerable by said debonding activator as such to decrease adhesion when triggered by said debonding activator. When the adhesive system is part of a panel, and forms or is part of a unit of said panel according to the first aspect, said additives are triggerable by said debonding activator as such to decrease adhesion between respective units of the panel. When the adhesive system is used to glue down a panel, said additives are triggerable by said debonding activator as such to decrease adhesion between the panel and the underlaying surface to which the panel is glued by said adhesive system, when triggered by said activator.

The additives can be any of the said additives that are described in the first aspect of the invention.

In a preferred embodiment, the additives are chosen from the list comprising: evaporable capsules, metallic particles, ferromagnetic particles, thermally expanding particles (e.g. expandable thermoplastic microspheres encapsulating a gas which can expand and break the microspheres when heat is applied), blowing agents, intumescent particles, azodicarbanamide, expandable graphite, polycarboxylic acids, sulphonylhydrazide and/or fibers.

In a preferred embodiment, the adhesive system comprises a curable glue. In a particularly preferred embodiment, said glue is curable by a heat and/or irradiation.

In a third independent aspect, the present invention concerns a method for disassembling a panel according to the first aspect of the invention, wherein a debonding activator, such as temperature and/or humidity and/or radiation and/or chemicals, is provided to allow separation of said units.

Preferably, the debonding activator used in the method can be any of the debonding activators used in a panel according to the first aspect of the invention, or any other suitable debonding activator, without departing from the scope of the present invention.

Preferably, the debonding activator comprises heat and/or humidity and/or radiation and/or chemicals. It should be understood that the debonding activator could comprise other components, without departing from the scope of the present invention. Preferably, the debonding activator may include at least two different components, such as for example heat and humidity, or heat and radiation.

In a particularly preferred embodiment, said debonding activator comprises at least heat and humidity. Preferably, the method includes subjecting a panel comprising at least a base unit which is HDF unit and a bonding unit which is a hydrophobic material unit to a debonding activator, wherein said at least two units are separated by heat and pressure.

In a preferred embodiment of the third aspect of the invention, the debonding activator decreases the adhesion of the bonding unit between itself and the at least one other unit, to allow separation of the said units.

In a preferred embodiment of the third aspect of the invention, the panel is a panel comprising at least two base units, wherein the at least two base units comprise a first base unit and a second base unit; wherein said bonding unit provides an adhesive bonding between the first base unit and the second base unit. The method comprises the step of separating the first base unit from the second base unit at least in part by the action of the debonding activator.

It is a benefit of this embodiment that the first base unit (e.g. a decorative top layer of the panel) is separated from the second base unit (e.g. providing the substrate of the panel), such that the first base unit and/or the second base unit can be re-used. The re-use of the second base unit is of particular interest, as it can provide the substrate for a new decorative panel by applying a new decorative top layer onto this second base unit.

A fourth independent aspect of the invention relates to a method for manufacturing a panel, wherein the method comprises a method according to any embodiment of the third aspect of the invention. The method of the fourth independent aspect comprises the step of applying a decorative top layer comprising a décor layer onto the second base unit obtained from the method according to the third aspect of the invention.

The method of the fourth independent aspect has the benefit that material-in particular the second base unit-is re-used to manufacture a new decorative panel.

Preferably, the decorative top layer applied to the second base unit comprises a décor layer comprising a printed décor; preferably a digitally printed décor.

Preferably, the decorative top layer comprises a resin impregnated printed paper sheet, a printed polymer film, a high pressure laminate (HPL) or a veneer.

Preferably, the decorative top layer comprises a surface texture. More preferably, the surface texture is provided in register with the printed décor. This surface texture is preferably provided via digital texturing.

In a fifth independent aspect, the present invention concerns a use of an adhesive system according to the second aspect of the invention, to form panels and/or to install panels by glue down installation.

It is clear that the adhesive system of the second independent aspect is ideally suited for forming or helping to form the bonding unit of the panel according to the first aspect of the invention. This also applies to the preferred embodiments of the first aspect of the invention. The adhesive system of the second independent aspect may show correspondingly preferred features as disclosed for the panel according to the first aspect. Moreover, it should be clear that the debonding activator employed in the method according to a third aspect of the invention can have all of the characteristics of the debonding activator as mentioned in the panel of the first independent aspect and/or the preferred embodiments thereof.

The sixth aspect of the invention relates to a method for removing floor panels or a floor sheet from a base. The floor panels or the floor sheet is adhered to the base by an adhesive system as in any embodiment of the second aspect of the invention. The method comprises the step of applying a debonding activator thereby decreasing the adhesion provided by the adhesive system between on the one hand the floor panels or the floor sheet and on the other hand the base; and removing the floor panels or floor sheets from the base.

It is a benefit of the sixth aspect of the invention that the floor panels of the floor sheet can be removed easily from the base. It is a further benefit that this removal can be done in a way that allows reuse of the floor panels or the floor sheet.

In a preferred embodiment of a method according to the sixth aspect of the invention, the floor panels or the floor sheet comprise at the back an adhesive system as in any embodiment of the fifth aspect of the invention; and the floor panels or the floor sheet is adhered to the base by a glue.

It is a benefit of such embodiment that the adhesive system provides a layer at the back of the floor panels of the floor sheet that can create the debonding when applying a debonding activator, when the floor panels or the floor sheet glued on to the base. A classical glue can be used for gluing the floor panels or the floor sheet to the base, e.g. a polyvinyl acetate glue.

A floor panels or a floor sheet comprising at its back an adhesive system as in any embodiment of the sixth aspect of the invention is in itself an independent aspect of the invention. Such floor sheet can e.g. be a polyvinyl chloride (PVC) based floor sheet.

In a preferred embodiment of the method of the sixth aspect of the invention, an apparatus is used for applying the debonding activator, wherein the apparatus is portable or on wheels.

Such embodiment facilitates the application of the debonding activator.

The apparatus can be an infrared generating device or a steaming unit.

With the intention of better showing the characteristics according to the invention, in the following, as an example without limitative character, some embodiments are described, with reference to the accompanying drawings, wherein:

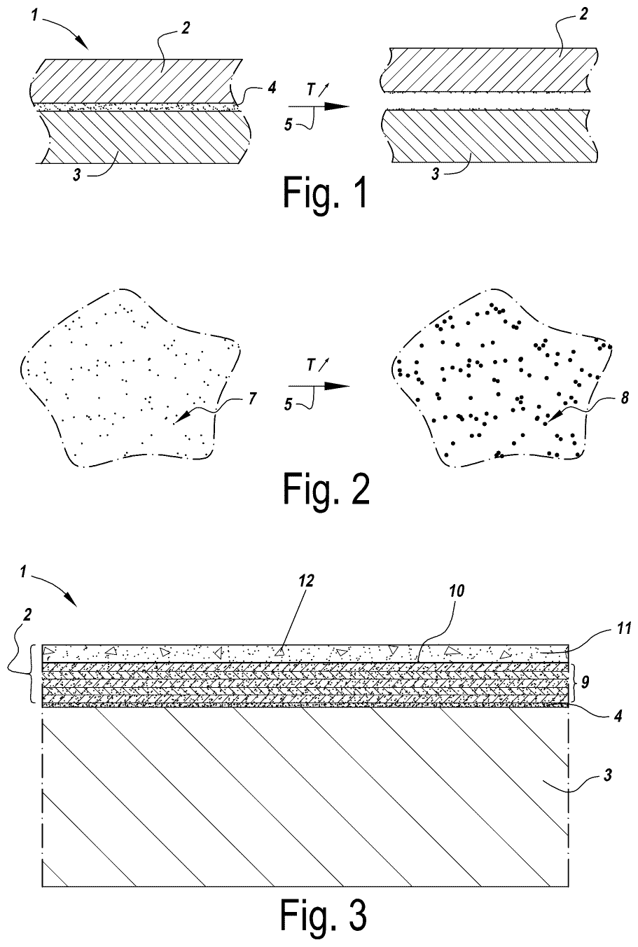

FIG. 1 diagrammatically shows a panel according to the first aspect of the invention; and

FIG. 2 diagrammatically shows an embodiment of the method according to the third aspect of the invention;

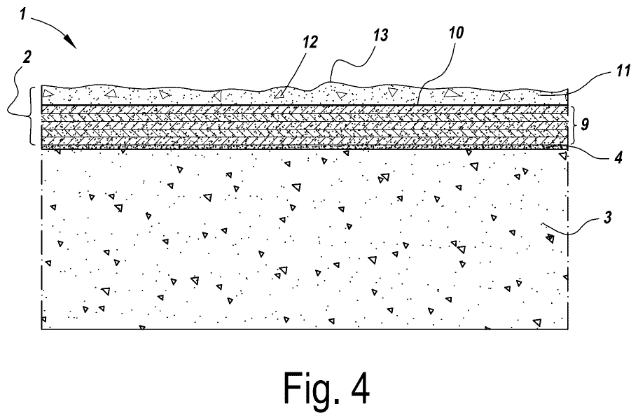

FIGS. 3 and 4 show cross sections of preferred embodiments of panels according to the first aspect of the invention.

FIG. 1 shows a panel 1 according to the first aspect of the invention, which panel 1 comprises a first base unit 2, a second base unit 3, and a bonding unit 4. Upon the exposure of the panel 1 to a debonding activator 5, which comprises heat and possibly humidity and/or radiation and/or chemicals, the adhesive bond strength of the bonding unit 4 decreases, so that the detachment i.e. delamination of the first base unit 2 and the second base unit 3 can become easier and the process of separating the units more efficient.

FIG. 2 shows expandable, in particular swelling particles 7, which swelling particles 7 increase in volume upon the exposure to a debonding activator, such as humidity and/or temperature. The swelling particles 7 upon the exposure to the debonding activator 5 become swelled particles 8, with an increased volume in comparison to the initially present volume of said swelling particles 7.

FIG. 3 shows a cross section of a panel 1, said panel 1 comprising a first base unit 2 being a HPL (High Pressure Laminate), said HPL comprising multiple resin impregnated paper layers 9, and a resin impregnated paper layer having a décor 10 and a resin impregnated paper being a wear layer 11 comprising corundum particles 12. Said HPL 2 is in contact with a bonding unit 4, said bonding unit 4 being a thermoplastic layer comprising metallic particles as additives. The second base unit 3 is a thermoplastic layer, for example an SPC (Solid Plastic Composite) layer.

FIG. 4 shows a cross section of a panel 1, said panel 1 comprising a first base unit 2 being a HPL which is of the same constitution as the HPL of FIG. 3, but further comprising embossments 13 on the surface of the panel 1, i.e. said embossments 13 being present in the wear layer 11, providing a three-dimensional structure on the surface and thus a natural and appealing look. Said HPL 2 is in contact with a bonding unit 4, which bonding unit 4 comprises a thermoset resin comprising thermally expandable glass microspheres. The second base unit 3 is a magnesium oxide mineral board.

With the aim of still further illustrating the features of the invention, here below, some examples and the results obtained are listed.

### Example 1

A panel, which panel comprises a first base unit which is a HPL (High Pressure Laminate) or a CPL (Continuous Pressure Laminate) of the construction as follows: two or more impregnated kraft paper layers as an underlay, a printed décor paper and optionally a wear layer comprising corundum particles. This first base unit is glued, by a bonding unit, to a second base unit comprising at least a thermoplastic material (PVC or polyolefin based, or a mixture of the two), said two base units being connected by said bonding unit comprising at least carbon nanotubes particles dispersed in a polyester based thermoplastic material. Said panel was placed on a hard underfloor and heated by a heater to a temperature not exceeding 90° C. Upon 45 min of heating, the decrease of the adhesive bond strength was visible and tangible, and upon 60 minutes the first base unit could be easily separated from the second base unit. Upon the separation, only minor residues of the bonding unit were present in said base units.

The second base unit can be reused by applying another first base unit—e.g. a HPL (High Pressure Laminate) or a CPL (Continuous Pressure Laminate)—comprising a different printed décor onto the second base unit in order to produce a new decorative panel.

### Example 2

A panel, which panel comprises a first base unit, with a wood veneer with optionally a lacquer layer and/or optionally a wear layer, and a second base unit, comprising at least a thermoplastic material (PVC or polyolefin based, or a mixture of the two) the two base units being connected by a bonding unit comprising at least carbon nanotubes particles dispersed in polyester based thermoplastic material. Said panel was placed on a hard underfloor and heated by a heater to the temperature not exceeding 90° C. Upon 45 min of heating, the decrease of the adhesive bond strength was visible and tangible, and upon 60 minutes the first base unit could be easily separated from the second base unit. Upon the separation, only the minor residues of the bonding unit were present in said base units.

### Example 3

A panel, which features: a first base unit which is HPL comprising two or more impregnated kraft paper layers as an underlay, a printed décor paper and optionally a wear layer comprising corundum particles; and a second base unit being a mineral based board such as a magnesium oxide board, which first and second units are adhered together by means of a bonding unit being a thermoset resin comprising thermally expandable glass microspheres. The panel is subjected to a temperature of about 100° and an increased humidity, the pressure being for example about 12-13 bar and the delamination of the units of the panel is monitored after 30 min, 1 h, 2 h and 3 h. The visible “loosening” of the bonding unit was detectable after 1 h, while after 3 h the first and the second base units could be separated without excessive force. Upon the separation, only minor residue of the bonding unit remained on the first and the second base unit, making the “delamination” of the panel relatively easy.

### Example 4

A panel which features a wood based HDF (High Density Fiberboard) base unit, with wood particles scattered in a thermoplastic glue such as polyvinyl butyral (PVB) glue and a bonding unit comprising a paper decorative top layer which is impregnated with a melamine formaldehyde resin comprising additives, was exposed to steam with a temperature of about 195° C. and a pressure of about 13-14 bar for 1 h. Upon 1 h, the bonding unit was completely detached from the HDF, with no visible residue of the paper on the HDF. Thus, steam as a debonding activator may be suitable for delamination of this panel.

### Example 5

An example of an adhesive system as in the sixth aspect of the invention has been applied to the back of a polyvinyl chloride based floor sheet. The example of the adhesive system comprises a polyamide polymer and expandable thermoplastic microspheres encapsulating a gas which can expand and break the microspheres when heat is applied in. After application of this solvent-based adhesive system to the back of the floor sheet, the adhesive system is dried. A non-tacky layer is obtained. The floor sheet has been glued onto a base using a polyvinyl acetate glue. The floor sheet could be successfully debonded from the base using a steaming unit. The heat from the steam of the steaming unit caused the gas in the microspheres to expand, thereby breaking the microspheres and the bond between the floor sheet and the polyvinyl acetate glue layer.

The present invention is not limited to the preferred embodiments described here above, but such methods and apparatuses may be realized according to several variants without leaving the scope of the invention.

1-47. (canceled)

48. A panel comprising two or more units connected to each other, wherein at least one of said units is a bonding unit that provides adhesion between itself and at least one other said unit,
wherein said adhesion is decreasable by a debonding activator,
wherein said debonding activator is selected from heat, humidity, radiation, chemicals, or combinations thereof.

49. The panel according to claim 48, wherein said units comprise at least two base units,
wherein said bonding unit comprises a glue which connects said at least two base units to each other.

50. The panel according to claim 48, wherein said units comprise at least two base units,
wherein the at least two base units comprise a first base unit and a second base unit;
wherein said bonding unit provides an adhesive bonding between the first base unit and the second base unit.

51. The panel according to claim 50, wherein the first base unit provides a top layer to the panel and the second base unit provides a substrate to the panel,
wherein the top layer comprises a décor layer comprising a printed décor; a digitally printed décor, or
wherein the top layer comprises a veneer,
wherein the first base unit comprises a resin impregnated printed paper sheet, a printed polymer film, or a high-pressure laminate (HPL).

52. The panel, according to claim 50, wherein the second base unit is selected from a wood-based board, a synthetic-based board, or a mineral board.

53. The panel as in claim 50, wherein said bonding unit comprises additives providing that said adhesive bonding is decreasable by a debonding activator;
wherein said additives are selected from one or a combination of more than one of the list consisting of metallic particles;
non-metallic particles;
thermally expanding particles, e.g. expandable thermoplastic microspheres encapsulating a gas which can expand and break the microspheres when heat is applied;
blowing agents;
hydrolysable agent;
azodicarbanamide;
expandable graphite;
polycarboxylic acids;
sulphonylhydrazides;
additives capable of changing from crystalline to amorphous form and/or from amorphous to crystalline form.

54. The panel according to claim 49, wherein said panel comprises at least a first said base unit comprising a HPL or a CPL or one or more veneers, and a second said base unit comprising a thermoplastic based layer; or alternatively said panel comprises at least a first said base unit comprising a HPL or a CPL or one or more veneers or a thermoplastic material and a second said base unit comprising a mineral based layer, said second base unit being a magnesium oxide board, a cement board or a geopolymer board;
wherein said panel further comprises a said bonding unit comprising additives, said additives being one or more of:
metallic particles;
non-metallic particles;
thermally expanding particles; e.g. expandable thermoplastic microspheres encapsulating a gas which can expand and break the microspheres when heat is applied;
blowing agents;
hydrolysable agents;
azodicarbanamide;
expandable graphite;
polycarboxylic acids;
sulphonylhydrazides;
additives capable of changing from crystalline to amorphous form and/or from amorphous to crystalline form.

55. The panel according to claim 49, wherein said at least two base units are layers connected one above the other, and said bonding unit is a glue layer comprising said glue, with said glue layer connecting said at least two base units.

56. The panel according to claim 49, wherein at least one base unit comprises one or more of the following characteristics and/or materials:
thermal resistance of at most 0.07 m2 K/W;
coefficient of thermal conductivity of at least 0.1 W/mK;
conductive additives, such as metallic (nano) particles and/or carbon based (nano) particles and/or nonmetallic (nano) particles;
a thickness of at most 5 mm;
is substantially free from voids, such as air pockets;
thermally expandable particles and/or blowing agents;
swellable material;
supramolecular polymers;
ferromagnetic particles;
hydrolysable glue.

57. The panel according to claim 48, wherein said base units comprise cellulosic particles, and said bonding unit connects said cellulosic particles.

58. The panel according to claim 48, wherein the said two or more units are layers, with said layers connected one above the other, and
wherein said bonding unit is a layer comprising a thermoplast providing at least partly said adhesion, or a layer comprising a thermoset resin.

59. The panel according to claim 48, wherein said two or more units comprise at least two bonding units.

60. The panel according to claim 48, wherein the bonding unit comprises a glue and additives,
wherein said glue provides said adhesion, and
wherein said additives are provided to decrease said adhesion when triggered by said debonding activator.

61. The panel according to claim 60, wherein the additives are swellable additives and/or expandable additives and/or conductive additives and/or hydrolysable additives.

62. The panel according to claim 60, wherein the debonding activator comprises at least moisture, is steam with a temperature of at least 195° C. and/or a pressure of at least 13-14 bar, and
wherein the additives are chosen from the list:
cellulosic particles;
plant based fibers; and/or thermally expanding particles.

63. The panel according to claim 60, wherein the debonding activator comprises at least temperature, and
wherein the additives are chosen from the list:
thermally expanding particles;
metallic particles, such as ferromagnetic particles;
non-metallic particles, such as carbon nanotubes.

64. An adhesive system for panels comprising one or more units, wherein said adhesive system is suitable for providing adhesion between itself and at least one unit of a said panel,
wherein the said adhesion is decreasable by a debonding activator, selected from temperature, humidity, radiation, chemicals, or combinations thereof.

65. The adhesive system according to claim 64, the adhesive system comprises a curable glue.

66. A method for disassembling a panel according to claim 48, wherein a debonding activator selected from temperature, humidity, radiation, chemicals or combinations thereof, is provided to allow separation of said units,
wherein the debonding activator decreases the adhesion of the bonding unit between itself and the at least one other unit, to allow separation of the said units.

67. The method according to claim 66, wherein said units comprise at least two base units,
wherein the at least two base units comprise a first base unit and a second base unit;
wherein said bonding unit provides an adhesive bonding between the first base unit and the second base unit;
wherein the method comprises the step of separating the first base unit from the second base unit at least in part by the action of the debonding activator.
